(19) United States
(12) Patent Application Publication
(10) Pub. No.: US 2018/0247450 A1
(43) Pub. Date: Aug. 30, 2018

(54) A COMPUTER-IMPLEMENTED METHOD AND A SYSTEM FOR CREATING A THREE-DIMENSIONAL MINERAL MODEL OF A SAMPLE OF A HETEROGENOUS MEDIUM

(71) Applicant: SCHLUMBERGER TECHNOLOGY CORPORATION, Sugar Land, TX (US)

(72) Inventors: Igor Andreevich Varfolomeev, Moscow (RU); Ivan Victorovich Yakimchuk, Moscow (RU); Dmitry Alexandrovich Korobkov, Moscow (RU); Boris Dmitrievich Sharchilev, Moscow (RU)

(21) Appl. No.: 15/757,489

(22) PCT Filed: Sep. 3, 2015
(86) PCT No.: PCT/RU2015/000559

§ 371 Date: Mar. 5, 2018

(51) Int. Cl. G06T 17/10; G06T 15/08; G06T 7/60; G06T 7/33; G06T 7/564

(52) U.S. Cl. CPC G06T 17/10; G06T 15/08; G06T 7/60; G06T 7/33; G01N 23/046; G06T 2207/10081; G06T 2207/10121; G06T 2207/10061; G06T 7/564

(57) ABSTRACT

An initial 3D microstructural image of at least a part of a sample consisting of at least one mineral is obtained. Then, a mineral distribution image of at least one part of the sample is obtained so that each obtained mineral distribution image at least partially overlaps with the obtained initial 3D microstructural image and spatial registration with the obtained initial 3D microstructural image is provided in overlapping regions. Then at least one local feature in each point of the obtained initial 3D microstructural image is extracted by a computing system. A correspondence is found between the extracted local features in each point of the overlapping regions in the obtained initial 3D microstructural image and the minerals in the corresponding points in the overlapping regions in the obtained mineral distribution images. The extracted local features in each point of the obtained initial 3D microstructural image and the found correspondence are used for segmenting the obtained initial 3D microstructural image. A 3D mineral model of the sample is created from the segmented initial 3D microstructural image.

### TECHNICAL FIELD

The invention relates generally to the field of estimating properties of heterogeneous media. More specifically, the invention relates to methods for imaging and mineralogical analysis of a sample of a heterogeneous medium.

### BACKGROUND OF THE INVENTION

The task of mineral (chemical) content determination is rather well-known. Some experimental methods allow direct acquisition of 3D images containing mineralogical (chemical) information. For example, X-ray Fluorescence microtomography provides 3D distribution of chemical elements non-destructively, and thus allowing creation of 3D mineral map. However, commercially available X-ray fluorescence microtomography devices use X-ray tubes as X-ray source. Their limited output brightness results in slow acquisition speed, low counts-per-voxel and/or limited resolution. Even when using a very bright synchrotron source, suitable sample size remains very limited (usually up to 0.1 mm), since too thick sample would completely absorb its own X-ray fluorescence. Till nowadays there is no efficient laboratory technique for direct 3D mineral mapping of samples larger than 1 mm.

It is known an indirect method for 3D mineral mapping of a rock sample (WO2013058672) disclosing linking gray values in 3D X-ray microtomography (microCT) image with different densities and chemical composition, such as different mineral. The method described there lacks explicit feature extraction step (it only mentions one feature—X-ray attenuation coefficient) and automated sample-specific “calibration” of characteristic feature values, related to specific mineral. To improve the previous method another indirect approach (US20150104078A1) consists in combination of microCT results and scanning electron microscopy (SEM) with energy dispersive spectrometry (EDS or EDX) data. The latter allows capturing mineral distribution on the surface by separate detecting and analyzing X-ray spectra emitted from every point of the surface. The idea of the method is to match microCT image with SEM mineral one. The simplest way was proposed only—to correlate directly values in the points of 3D microCT image with mineral entities in corresponding points of mineral distribution image. Such approach is not universal and can be inefficient (e.g. in case of minerals with close values on microCT image such as Albite and Quartz, Dolomite and Halite, etc.).

### SUMMARY OF THE INVENTION

According to embodiment of the invention, the method comprises obtaining an initial 3D microstructural image (such as microCT) of at least a part of a sample of a heterogeneous medium, the sample consists of at least one mineral. Then, a mineral distribution image of at least one part of the sample is obtained so that each obtained mineral distribution image at least partially overlaps with the obtained initial 3D microstructural image and spatial registration with the obtained initial 3D microstructural image is provided in overlapping regions.

Then at least one local feature in each point of the obtained initial 3D microstructural image is extracted by a computing system. A correspondence is found, by the computing system, between the extracted local features in each point of the overlapping regions in the obtained initial 3D microstructural image and the minerals in the corresponding points in the overlapping regions in the obtained mineral distribution images. The extracted local features in each point of the obtained initial 3D microstructural image and the found correspondence between the extracted local features and the minerals are used for segmenting, by the computing system, the obtained initial 3D microstructural image. A 3D mineral model of the sample is created from the segmented initial 3D microstructural image.

### BRIEF DESCRIPTION OF THE DRAWINGS

The disclosure is illustrated by drawings where:

FIG. 1 is a flow-chart illustrating an example method in accordance with some embodiments;

FIG. 2 illustrates a detailed workflow of feature extraction in accordance with some embodiments;

FIG. 3 shows an example of a microstructural image;

FIG. 4 illustrates an example of features that can be extracted from the image;

FIG. 5 explains the effective approach for spatial registration of a 2D mineral distribution image with a 3D microstructural image of the same sample;

FIG. 6 illustrates a computing system in accordance with some embodiments;

FIG. 7 shows a 3D microstructural image of a sandstone and its 2D slice;

FIG. 8 illustrates the result of spatial registration of the 2D mineral distribution image with the 3D microstructural image of the same sample;

FIG. 9 illustrates the created 3D mineral map for the sandstone.

### DETAILED DESCRIPTION OF THE INVENTION

Reference will now be made in detail to embodiments, examples of which are illustrated in the accompanying figures.

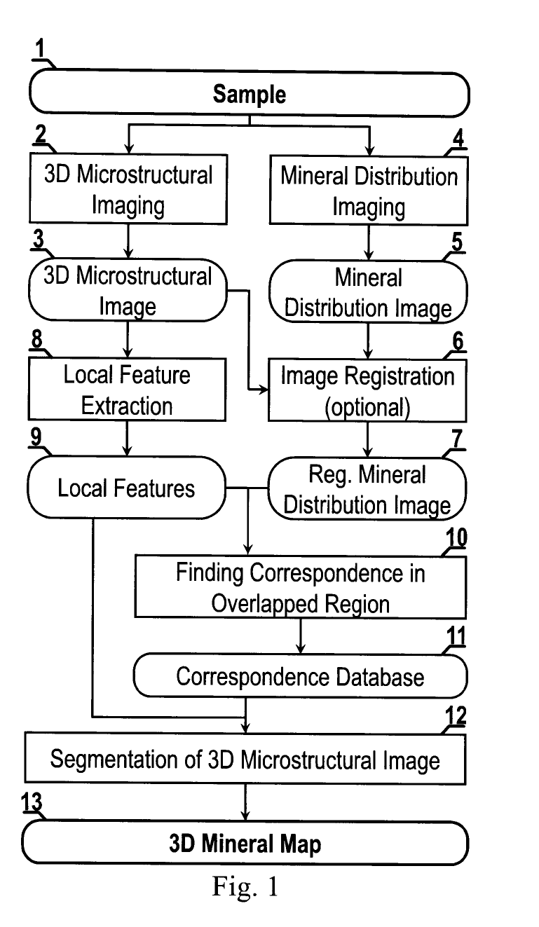

FIG. 1 shows a flowchart in accordance with one or more embodiments.

Block 1 corresponds to a heterogeneous media sample. For example, it can be a core sample consisting of rock minerals that was extracted from a near wellbore area.

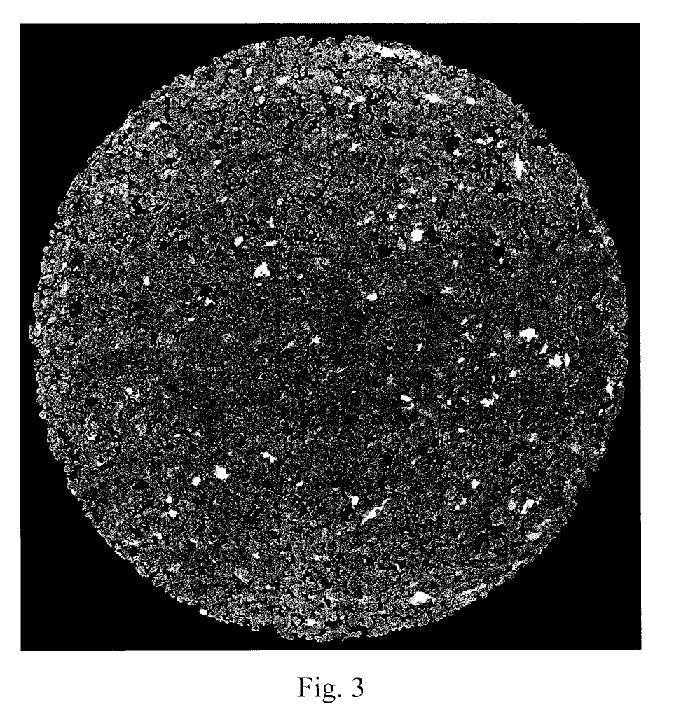

In Block 2 an initial 3D microstructural image (shown in Block 3) of at least a part of the sample is obtained via 3D microstructural imaging procedure. The 3D microstructural image shown in Block 3 is an image that explicitly or implicitly reflects the internal geometry and mineral heterogeneity in the sample. Digital representation of a 3D image is a 3D array of scalar or vector values. Each element of that array corresponds to a point in the image (pixel for 2D image and voxel for 3D image). A large number of methods and corresponding devices can provide a 3D microstructural image. Among them are such methods as X-ray micro- (nano-) tomography, X-ray fluorescence microtomography, neutron microtomography, 3D FIB-SEM, etc. and well-known devices for their realization. An example of X-ray microtomography image of a sandstone is presented on FIG. 3, where greyscale of the image from black to white corresponds to sample local X-ray attenuation from low to high absorption.

In one or more embodiments, the initial 3D microstructural image contains vector value (a set of scalar values) in each point (vector image). For example, image can be obtained as a combination of scalar microstructural images. E.g., several imaging experiments by various techniques can be applied to the same sample or the same technique with different parameters (e.g., X-ray tube voltage) of the setup can be conducted. Such image can be a result of multi-energy (including dual-energy) X-ray tomography, where the sample is scanned several times with different spectrum of X-ray beam. Each scan produces the 3D distribution of attenuation coefficients in the sample specific to the corresponding X-ray spectra. Thus, the result is 3D microstructural image with several numbers (attenuation coefficients) in each point. Generally, additional microstructural information increases the quality and efficiency of the whole method.

Further, a mineral information about the sample should be obtained. In Block 4 a mineral distribution image (Block 5) of at least one part of the sample is obtained by a mineral distribution imaging procedure so that each obtained mineral distribution image at least partially overlaps with the obtained initial 3D microstructural image (Block 3) and spatial registration with the obtained initial 3D microstructural image (Block 3) is provided in overlapping regions.

Hereinafter a mineral is a specific chemical substance (carbon, gold, specific metal alloy, etc.), or a specific mineral type (quartz, calcite, pyrite, etc.), or a specific mixture of minerals (e.g. 30% of feldspar and 70% of quartz), or a specific mixture of chemical substances (e.g. multilayer shell of a sample). Any of the above is considered as mineral. Hereinafter a mineral distribution image is an image where every point of the image can be interpreted as above defined mineral.

In one or more embodiments, the mineral distribution image (Block 5) can be two-dimensional. E.g., it can be 2D mineral map obtained by different methods with the use of corresponding devices. Thus, it can be obtained by scanning electron microscopy (SEM) with energy-dispersive spectroscopy (EDS) (Butcher, A. R., Helms, T. A., Gottlieb, P. et al., “Advances in the quantification of gold deportment by QemSCAN.” Seventh Mill Operators' Conference, Australasian Institute of Mining and Metallurgy, pp. 267-271, 2000). This method requires cutting the sample followed by polishing and coating with conductive material. In another embodiment, 2D mineral distribution can be acquired from traditional optical microscopy (e.g., petrographic analysis of rock samples). In one or more embodiments, other imaging techniques sensitive to chemical and mineral content can be applied. E.g., transmission electron microscopy (TEM) with electron energy loss spectra (EELS) analysis, confocal Raman spectroscopy, X-ray fluorescence microscopy.

In accordance with another embodiment of the invention, the mineral distribution image (Block 5) can be three-dimensional. In one or more embodiments, it can be synchrotron microtomography with monochromatic X-ray beam (F. Fusseis, X. Xiao, C. Schrank and F. De Carlo, “A brief guide to synchrotron radiation-based microtomography in (structural) geology and rock mechanics,” Journal of Structural Geology, vol. 65, pp. 1-16, 2014). The ability to resolve different minerals can be increased by scanning the sample several times with various energies (wavelengths) of X-ray beam—multi-energy microtomography. In another embodiment, SEM complemented with Focused Ion Beam (FIB) system can be used. It allows etching and imaging the surface of the object under study slice by slice. This technique may provide 3D image of the subsurface volume with ˜10 nm resolution and ˜10 μm field of view. Backscattered electron (BSE) detection together with EDS can provide mineral information for acquired 3D image. In one or more embodiments, other 3D imaging techniques sensitive to chemical and mineral content can be applied. E.g., 3D X-ray fluorescence microtomography, 3D confocal Raman spectroscopy, 3D X-ray topo-tomography.

In one or more embodiments, the mineral distribution image (Block 5) can be one-dimensional, i.e. mineral distribution of line profiles. E.g., it can be interpretation of scratching profilometers, temperature conductivity meters, which can be useful for standard core samples (Popov Yu., Pribnow D., Sass J., Williams C. and Burkhardt H. 1999. Characterization of Rock Thermal Conductivity by High-Resolution Optical Scanning. Geothermics, 1999, No. 28, pp. 253-276.). In another embodiment, 1D mineral distribution can be acquired from any kind of 1D laser spectroscopy. In one or more embodiments, other imaging techniques sensitive to chemical and mineral content can be applied. E.g., acoustic microscopy, SEM-EDS line profile, etc.

In accordance with aforesaid, any of these 1D, 2D or 3D mineral distribution images should be obtained at least partially inside the region (volume) of the sample previously captured by the initial 3D microstructural image. In one or more embodiments, several mineral distribution images can be obtained in several locations. Generally, additional mineral distribution images would increase the quality and efficiency of the whole method.

Any of these 1D, 2D or 3D mineral distribution images (Block 5) should be spatially registered with the obtained initial 3D microstructural image of the sample. In one or more embodiments, the 3D microstructural and the mineral distribution images are spatially registered originally due to the nature of image acquisition process. Potentially, both imaging experiments can be conducted in one setup without moving the sample providing already aligned images (e.g., microCT and SEM imaging inside one SEM chamber).

In accordance with another embodiment of the invention, the 3D microstructural and the mineral distribution images are spatially registered during additional processing step shown in Block 6 after acquisition of all images. An overview of the general problem of image registration and some approaches are considered in (Image registration methods: a survey; Barbara Zitova, Jan Flusser; Image and Vision Computing 21 (2003) 977-1000). In one or more embodiments, any of well-known image registration algorithms can be applied.

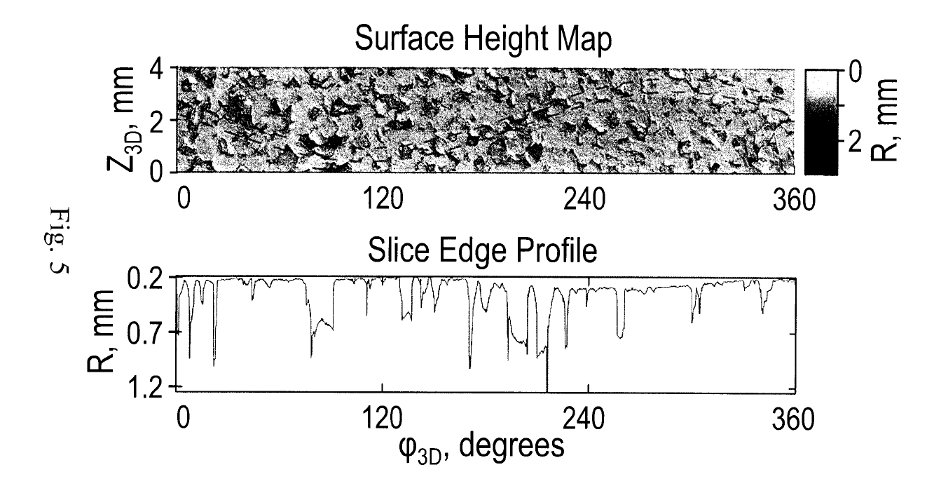

In other embodiments, the registration procedure shown in Block 6 can be based on structural peculiarities of the studied samples, e.g. side contour (for 2D mineral distribution images) or side surface (for 3D mineral distribution and microstructural images). E.g., rock samples for laboratory core analysis are typically cylindrically shaped. The side surface of such specimen is never ideally smooth due to rock nature (grains, fractures, voids). The side surface represented as height map (Surface Height Map in FIG. 5) clearly demonstrates this peculiarity of rock sample, where according to cylindrical coordinate system Z_{3D}—coordinate along vertical axis aligned with symmetry axis of cylindrical sample, φ_{3D}—azimuthal coordinate on the side surface of the cylindrical sample. A pair of coordinates (Z_{3D}, φ_{3D}) fully determine the point on a cylinder of a fixed radius. In accordance with aforesaid, points of a real side surface of a cylindrical sample have various distances p to a vertical axis of a sample. To emphasize this effect the value R is used in FIG. 5. For every pair of coordinates (Z_{3D}, φ_{3D}) the value R is determined as follows:

R(Z_{3D},φ_{3D})=ρₘₐₓ−ρ(Z_{3D},φ_{3D})),

where ρₘₐₓ is the maximum distance to a vertical axis of a sample among all points of the side surface of a sample.

The side surface (and its height map) is a rather unique descriptor of the sample. While the 1D contour of a 2D section (Slice Edge Profile in FIG. 5) with its maxima and minima rather explicitly corresponds to 2D side surface of 3D microstructural image. By fitting 1D contour with 2D side surface it is possible to find all necessary spatial transformation parameters (x-, y-, z-shifts, Euler angles, scale) with acceptable accuracy.

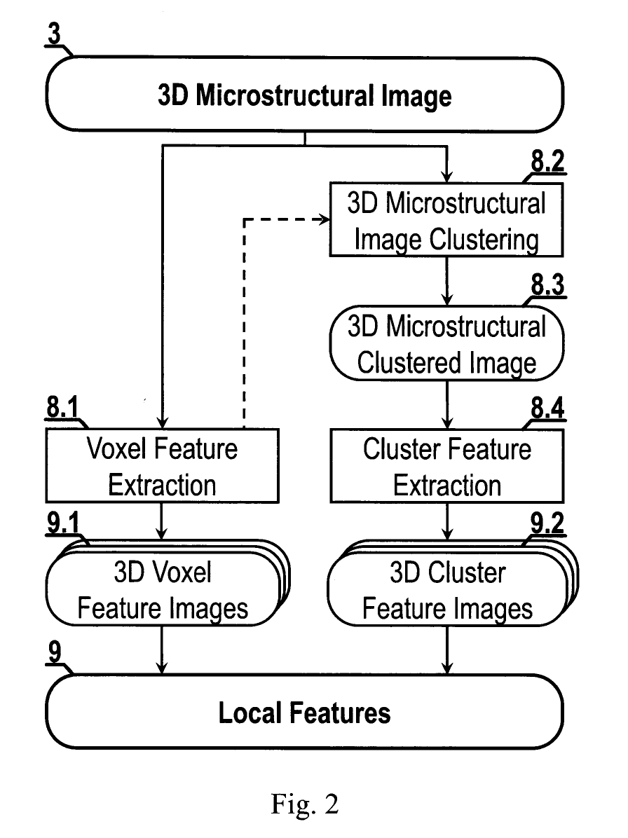

After obtaining the 3D microstructural and the mineral distribution images spatially registered with each other the procedure of merging information from all images should be started. As it was already said, the simplest way to match a microstructural image with a mineral one is just to correlate values in the points of the 3D microstructural image with minerals in corresponding points of the mineral distribution images directly. Such approach is not universal and can be inefficient. More robust method, proposed in this invention, consists in extracting (Block 8) (calculating) various local features (Block 9) in points of the microstructural image prior to matching with the mineral distribution image. Examples of the local features (Block 9) are mean value, dispersion, skewness, kurtosis, median, complete histogram, average result of convolution with a specific kernel, local binary patterns, etc. One embodiment of the feature extraction (Block 8) is demonstrated in FIG. 2.

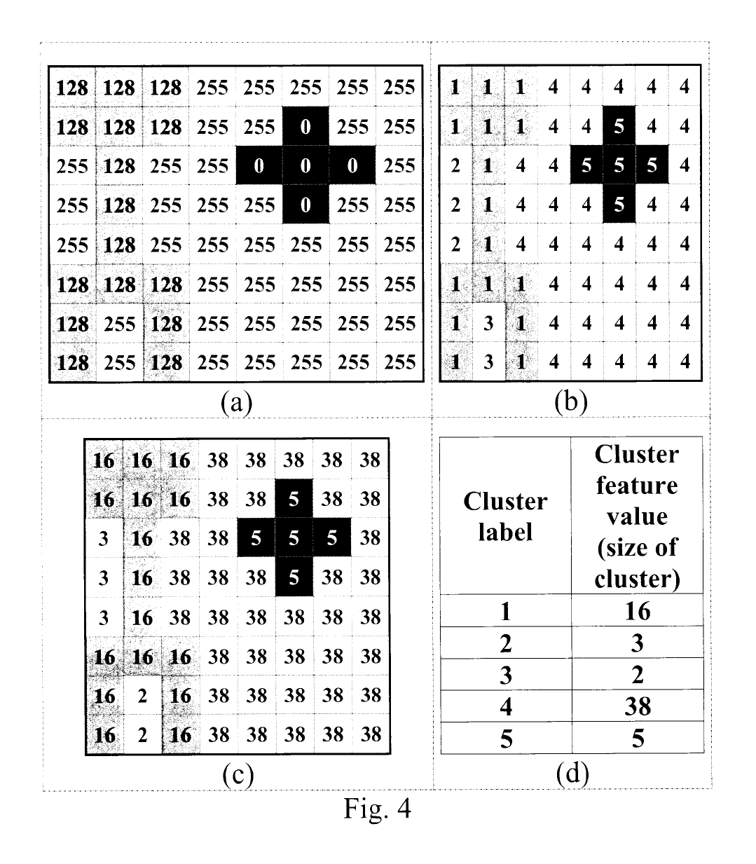

In one or more embodiments, the local features (Block 9) can be calculated in the neighborhood (window) of a point (voxel) in the 3D microstructural image (Voxel feature extraction—Block 8.1). Various sizes of the window produce feature values of different scales and, thus, can be considered as a separate local features. The procedure results in 3D distributions of voxel feature values—3D voxel feature images (Block 9.1). The initial 3D microstructural image is an example of 3D voxel feature image (Block 9.1) by itself, where each point (voxel) contains image intensity (e.g., X-ray local attenuation in X-ray microtomography images). Another example of 3D voxel feature image is the result of calculation a standard deviation value in every point (voxel) of the 3D microstructural image. In another embodiments, the local features can be calculated in a connected group of the voxels (cluster) constituting a single part of the structure (Cluster feature extraction, Block 8.4), e.g. mineral grain for rock sample. Such procedure produces 3D distributions of cluster feature values—3D cluster feature images (Block 9.2). An example of such cluster feature image is presented in FIG. 4c.

For cluster feature extraction (Block 8.4) the image should be clustered (Block 8.2) before, i.e. the structure in the image should be split on separate objects (e.g., grains). In one or more embodiments, it could be done by watershed algorithm (Serge Beucher and Christian Lantuéjoul, Use of watersheds in contour detection, In International workshop on image processing: Real-time edge and motion detection. Rennes, France, 17-21 Sep. 1979) and its posterior modifications. It should be noted, that clustering (Block 8.2) could be done either on the obtained 3D microstructural image itself (Block 3) or on the mineral distribution image (Block 5 on FIG. 1). In one or more embodiments, clustering (Block 8.2) of 3D microstructural image can be done using results (Block 9.1) of voxel feature extraction (Block 8.1), as some of the extracted local features can simplify the clustering procedure (Block 8.2). Voxel (Block 8.1) and cluster (Block 8.4) feature extraction techniques can be applied in combination.

One embodiment of a process of the feature extraction is demonstrated in FIG. 2. An example of local features that can be extracted is shown in FIG. 4. The content of FIG. 4 is the following: (a) is a model of an initial 3D microstructural image (different values 0, 128 and 255 reflects different X-ray attenuation in greyscale in corresponding points due to different chemical composition), (b) are the results of clustering procedure (Block 8.2 on FIG. 2) and numbers from 1 to 5 are just the cluster labels, (c) is the cluster feature image corresponding to (a), where the feature is the cluster size (amount of pixels in the cluster), and (d) is the same information as in (c) in the form of table.

In compliance with the invention, at least one local feature in each point of the obtained initial 3D microstructural image is extracted (calculated).

In one or more embodiments, a set of any reasonable local features is extracted in each point of the regions of the microstructural image that overlap with the mineral distribution images. Further, the most significant features that provide distinction between the minerals are identified. Finally, only a set of these significant features is extracted from the whole 3D microstructural image.

In one or more embodiments, depending on application goals, the list of minerals that should be distinguished and finally mapped can be significantly reduced (e.g., only four mineral entities: quartz, calcite, feldspar and all others). In such cases, the number of required local features and the processing time can be essentially decreased.

Next step consists in finding a correspondence (Block 10 on FIG. 1) between the extracted (calculated) local features (Block 9) and minerals in the overlapping regions of all images (the initial 3D microstructural and the mineral distribution images). In one or more embodiments, various supervised machine learning algorithms are used.

The general principle of this class of algorithms is as follows. Suppose that there exists an unknown rule and/or a process (called “target function”) that, given an object from a certain set of similar (in some way) objects, produces a response of some kind. Possible types of responses include:
Class label for that object (e. g. type of mineral for an input rock grain);
Certain attribute of that object (e. g. size or shape of a grain);
etc.

Suppose that the responses are known only for a limited number of objects (called “training data”) from the aforementioned set. The process of learning from data is a process that takes training data as an input and, using certain data analysis techniques (called “machine learning algorithms”), produces an algorithm that is able to forecast the response of the target function for an arbitrary object from a generating set. Examples of machine learning algorithms include, but not limited to:
Pre-defining a set of possible probabilistic models of the data-generating process, selecting the model to which the observed data fits best, and using that model to produce the most likely response to each input object (Probabilistic machine learning algorithms);
Building logical decisive rules by separating the objects' features space into regions that correspond to regions of maximal likelihood for different possible responses and using these rules as response predictors (Logical algorithms);
etc.

In context of the problem under consideration, objects are points of the initial 3D microstructural image (Block 3), the target function's response is the mineral type in a corresponding point, and the training data are the pairs of correspondent points from the overlapped region of 3D microstructural image (Block 3) (including local feature values) and the registered mineral distribution image (Block 7 on FIG. 1). In one or more embodiments, a list of permitted mineral types for target function's response can be limited to a few minerals, which are significant for the study. For example, it may be known a-priori and proved by a mineral distribution image that the sample is composed mainly (99%) by quartz and feldspar. The fraction of all other minerals is less than 1%. In such case, it can be reasonable to find the correspondence between the minerals and local feature values for these two minerals (quartz and feldspar) only.

In one or more embodiments, the result of this step is a generated correspondence database (Block 11 on FIG. 1) of explicit mathematical conditions assigned for each mineral in the specimen.

Training procedure usually involves a lot of data processing and could take significant amount of time (much more than subsequent segmentation procedure). For that reason, in one or more embodiments, the results of training procedure are continuously accumulated in one common library that can be used for creating three-dimensional mineral maps (Block 13 on FIG. 1) of similar samples in similar 3D microstructural imaging conditions avoiding the acquisition (Block 4 on FIG. 1) of mineral distribution image and time-consuming training procedure for finding (Block 10 on FIG. 1) necessary correspondence. Such approach can be effective in case of stable and calibrated 3D microstructural images.

The obtained correspondence (Block 11) between the minerals and a set of local feature values (Block 9) in the points of the 3D microstructural image (Block 3) can be used now for segmentation of the whole 3D microstructural image—Block 12 on FIG. 1. In one or more embodiments, the discovered correspondence is inspected in every voxel of the 3D microstructural image point by point and the most satisfactory mineral type is assigned then. In another embodiment, the assignment of the mineral entities in every point is done taking into account local features of neighboring points. Thus, minerals in the neighboring points are not independent that is more correct physically. Such approach can be used for creating more regular solution of segmentation procedure.

In one or more embodiments, this procedure is computed in a parallel mode.

In another embodiment, the segmentation can include additional post-processing. For example, in real practice, direct segmentation based on discovered correspondence may lead to mineralogically inhomogeneous clusters in the structure, i.e. isolated voxels (or even small connected group of voxels) of one mineral inside the grain of another. Although it may be correct result, for some samples it can be an artifact. In one or more embodiments, such isolated voxels of one mineral inside another mineral are replaced by it.

Finally, in compliance with the invention, a 3D mineral map (or 3D mineral distribution image, or 3D mineral model) is constructed (Block 13 on FIG. 1). In one or more embodiments, it can be stored as a 3D array of identification numbers that unambiguously correspond to each mineral. This 3D dataset can be stored as one file or a set of 2D slices.

A system for creating a 3D mineral model of a heterogeneous media sample comprises a first image producing device configured to produce an initial 3D microstructural image of at least a part of the sample and a second image producing device for obtaining a mineral distribution image of at least one part of the sample so that each obtained mineral distribution image at least partially overlaps with the produced initial 3D microstructural image. The first device is selected from a group of devices providing such methods as X-ray micro- (nano-) tomography, X-ray fluorescence microtomography, neutron microtomography, 3D FIB-SEM, etc. The second device is selected in dependence of which kind of the mineral distribution image should be obtained—1D, 2D or 3D. Accordingly a Confocal Raman microscope, a Scanning Electron microscope, a Transmission Electron Microscope, different devices providing such methods as Optical microscope-based petrography analysis, X-ray fluorescence microtomography, Multi-energy microtomography can be used as the second device.

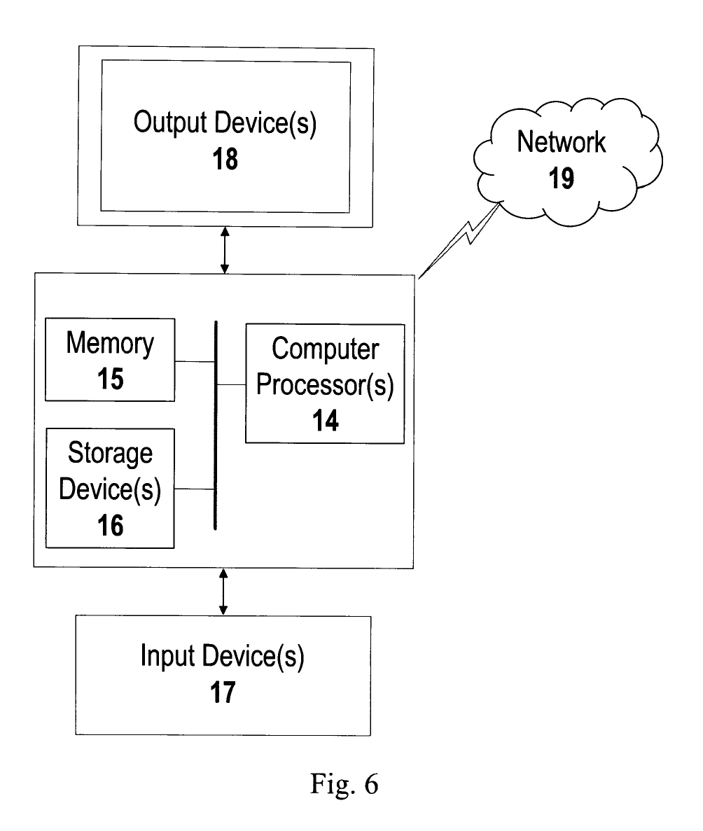

The method requires using a computing device coupled to the first and the second image producing devices. The computing device may include hardware, software, firmware, or a combination thereof. Various components of the computing device are described below with reference to FIG. 6.

As shown in FIG. 6, the computing device may be of virtually any type regardless of the platform being used. For example, the computing device may be one or more mobile devices (e.g., laptop computer, smartphone, smartwatch, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 6, the computing device may include one or more computer processor(s) 14, associated memory 15 (e.g., random access memory (RAM), cache memory, flash memory, etc.), one or more storage device(s) 16 (e.g., a hard disk, an optical drive such as a compact disk (CD) drive or digital versatile disk (DVD) drive, a flash memory stick, etc.), and numerous other elements and functionalities. The computer processor(s) 14 may be an integrated circuit for processing instructions. For example, the computer processor(s) may be one or more cores, or micro-cores of a processor. The computing device may also include one or more input device(s) 17, such as a touchscreen, keyboard, mouse, microphone, touchpad, electronic pen, or any other type of input device. Further, the computing device may include one or more output device(s) 18, such as a screen (e.g., a liquid crystal display (LCD), a plasma display, cathode ray tube (CRT) monitor, e-ink display, projector, or other display device), a printer, external storage, or any other output device. One or more of the output device(s) may be the same or different from the input device(s). The computing device may be connected to a network 19 (e.g., a local area network (LAN), a wide area network (WAN) such as the Internet, mobile network, or any other type of network) via a network interface connection. The input 17 and output 18 device(s) may be locally or remotely (e.g., via the network 19) connected to the computer processor(s) 14, memory 15, and storage device(s) 16. Many different types of computing devices exist, and the aforementioned input and output device(s) may take other forms.

Software instructions in the form of computer readable program code to perform one or more embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform one or more embodiments of the method.

Further, one or more elements of the aforementioned computing device may be located at a remote location and connected to the other elements over a network (19). Further, embodiments may be implemented on a distributed system having multiple nodes, where each portion of an embodiment may be located on a different node within the distributed system. In one or more embodiments, the node corresponds to a distinct computing device. Alternatively, the node may correspond to a computer processor with associated physical memory or to a computer processor or micro-core of a computer processor with shared memory and/or resources.

### Example of Invention Implementation

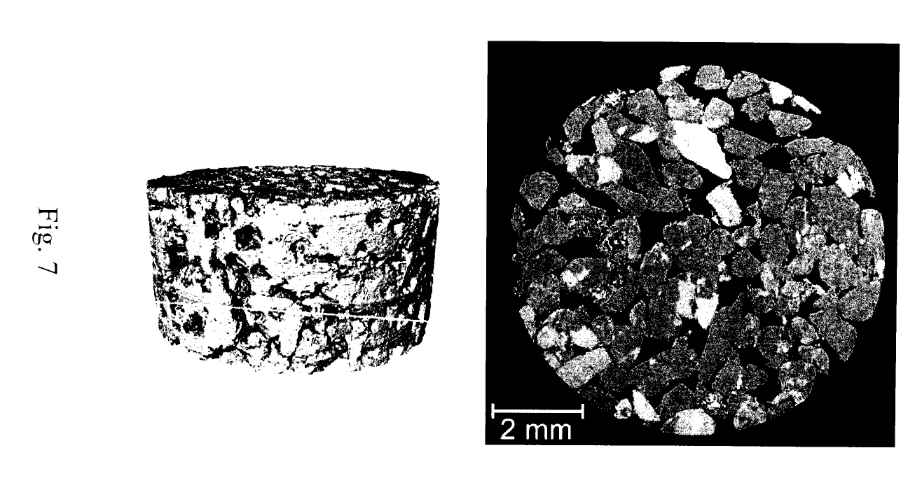

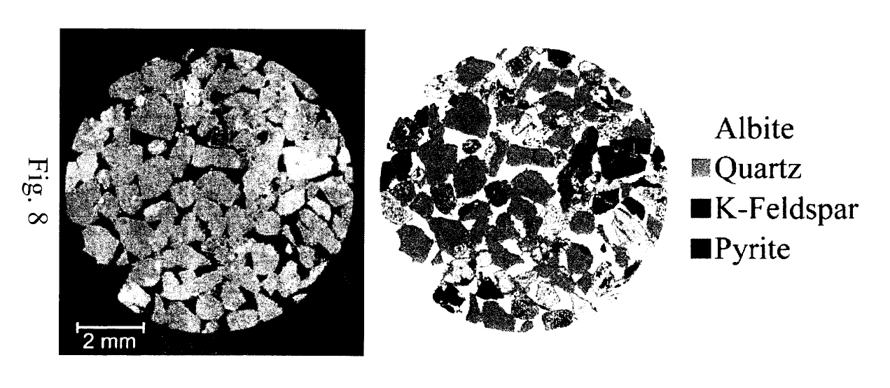

An initial 3D microstructural image I_{MS} (FIG. 7, left) of a sandstone sample have been obtained using microCT setup. A 2D slice of the initial 3D microstructural image I_{MS} is also shown in FIG. 7 (right). After that the sample was prepared for SEM imaging (including epoxy filling, cutting, grinding, polishing and carbon coating) and a 2D mineral distribution image I_{MD} have been constructed using EDS microanalysis technique (FIG. 8, right). Plane surface studied in SEM intersected the volume scanned in microCT experiment, thus providing an overlapping region between both images.

As both imaging procedures have been conducted in separate devices, acquired images are not aligned yet. In this case, additional image registration procedure is required (2D with 3D). Described contour-based image registration procedure (FIG. 5) have been used. The result of image registration is demonstrated in FIG. 8.

This overlapping region contains 4 major minerals: Quartz, Albite, K-Feldspar and Pyrite. In compliance with the invention, next step consists in calculating local features in the initial 3D microstructural image I_{MS} and finding the correspondence between feature values and mineral entities.

In this particular example, the following local features were extracted (calculated) by a computing device: voxel feature of mean greyscale value VMGS, voxel feature of local dispersion value VLD, cluster feature of mean greyscale value CMGS and cluster feature of special smoothness measure CSM.

According to aforementioned, voxel feature extraction corresponds to feature calculation in some neighborhood of every point (voxel) of the 3D microstructural image. In this particular case, Voxel feature of Mean GreyScale value was calculated as follows:

$$VMGS ( {i}_{0} , {j}_{0} , {k}_{0} ) = \frac{1}{27} {\sum }_{i = {i}_{0} - 1}^{{i}_{0} + 1} {\sum }_{j = {j}_{0} - 1}^{{j}_{0} + 1} {\sum }_{k = {k}_{0} - 1}^{{k}_{0} + 1} {I}_{MS} ( i , j , k ) ,$$

where i₀, j₀, k₀—are the coordinates of voxel under consideration.

Voxel feature of Local Dispersion value was calculated as follows:

$$VLD ( {i}_{0} , {j}_{0} , {k}_{0} ) = \frac{1}{27} {\sum }_{i = {i}_{0} - 1}^{{i}_{0} + 1} {\sum }_{j = {j}_{0} - 1}^{{j}_{0} + 1} {\sum }_{k = {k}_{0} - 1}^{{k}_{0} + 1} {( {I}_{MS} ( i , j , k ) - VMGS ( {i}_{0} , {j}_{0} , {k}_{0} ) )}^{2} ,$$

where i₀, j₀, k₀—are the coordinates of voxel under consideration.

The cluster feature extraction corresponds to feature calculation from each cluster of the structure. In this case, every mineral grain have been taken as a cluster. Generally, for consolidated samples all grains touch each other. To separate them on disjoint grains well-known watershed procedure was performed (Serge Beucher and Christian Lantuéjoul. Use of watersheds in contour detection, In International workshop on image processing: Real-time edge and motion detection. Rennes, France, 17-21 Sep. 1979). Having obtained separated structure of grains in 3D microstructural image, another well-known labeling procedure [https://en.wikipedia.org/wiki/Connected-component_labeling] is applied, which assign identification number n for each separated grain (FIG. 4b is an example).

After that, mentioned cluster feature values were calculated for each cluster. Cluster feature of mean greyscale value CMGS was calculated as follows:

$${CMGS}_{n} = \frac{1}{{N}_{n}} {\sum }_{i ∈ {C}_{n}} {\sum }_{j ∈ {C}_{n}} {\sum }_{k ∈ {C}_{n}} {I}_{MS} ( i , j , k ) ,$$

where i, j, k—are the coordinates of voxels belonging to the cluster Cₙ with identification number is the number of voxels in the cluster Cₙ.

Cluster feature of special smoothness measure CSM was calculated as follows:

CSMₙ=Median_{0.8}(Dₙ),

Dₙ={VLD(i,j,k)},(i,j,k)∈Cₙ,

where i, j, k—are the coordinates of voxels belonging to the cluster Cₙ with identification number n; Dₙ is a set of VLD values in cluster Cₙ; Median_{0.8} of set Dₙ corresponds to an element that separates the lower (in terms of values) part of the set Dₙ from higher part. The serial number of this separation element in ordered set Dₙ is equal to 0.8Nₙ, where Nₙ—is the number of voxels in the cluster Cₙ. E.g., Median_{0.5}(Dₙ) is the classical median of a set Dₙ, which corresponds to number in the middle of ordered set Dₙ:

Median_{0.5}({5;0;2;10;7})=Median_{0.5}({0;2;5;7;10})=5,

Median_{0.8}({5;0;2;10;7})=Median_{0.8}({0;2;5;7;10})=7.

As far as the local features are calculated, it is possible to start the training procedure. According to the invention, the training data are the pairs of correspondent points from the overlapped region of 3D microstructural image (including all local feature values) and registered mineral distribution image. In this particular case, each point (pixel) of overlapped region (2D plane section of the sample) can be attributed with mineral type (from mineral distribution image), greyscale value (from 3D microstructural image), and local feature values (VMGS, VLD, CMGS, CSM). The decision tree learning [https://en.wikipedia.org/wiki/Decision_tree_learning] method have been used for finding necessary correspondence between mineral types (Quartz, Albite, K-Feldspar and Pyrite) and their local features on 3D microstructural image (greyscale value in voxel, VMGS, VLD, CMGS, CSM). As the result, the following correspondence was found:

| Mineral Type | VMGS | CMGS | CSM |
|---|---|---|---|
| Quartz | 94 ± 7 | 94 ± 2 | 1.7 ± 0.3 |
| Albite | 95 ± 8 | 95 ± 2 | 4.1 ± 2.0 |
| K-Feldspar | 108 ± 11 | 101 ± 3 | — |
| Pyrite | 205 ± 50 | — | — |

As one can see, the VMGS feature is sufficient for identification of Pyrite inclusion, but Quartz, Albite and K-Feldspar have intersection region in VMGS values range. Calculation of CMGS allow distinction of K-Feldspar clusters from Quartz and Albite. Finally, CSM feature provides differentiation between Quartz and Albite.

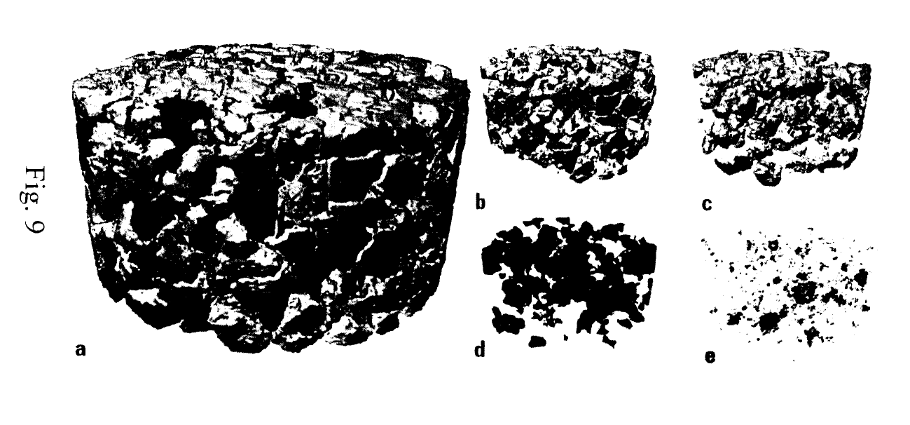

Final 3D Mineral Map (FIG. 9) have been constructed by segmentation the 3D microstructural image applying found correspondence between the microstructural image and the mineral entities from the mineral distribution images. The content of FIG. 9 is the following: (a)—full 3D mineral map; (b)—quartz 3D distribution; (c) albite 3D distribution; (d) K-feldspar 3D distribution and (e) pyrite 3D distribution.

1. A computer-implemented method for creating a three-dimensional mineral model of a heterogeneous media sample comprising:
obtaining an initial 3D microstructural image of at least a part of the sample, the sample consists of at least one mineral,
obtaining a mineral distribution image of at least one part of the sample so that each obtained mineral distribution image at least partially overlaps with the obtained initial 3D microstructural image and a spatial registration with the obtained initial 3D microstructural image is provided in overlapping regions,
extracting, by a computing device, at least one local feature in each point of the obtained initial 3D microstructural image,
finding, by the computing device, a correspondence between the extracted local features in each point of the overlapping regions in the obtained initial 3D microstructural image, and at least part of minerals in the corresponding points in the overlapping regions in the obtained mineral distribution images,
segmenting, by the computing device, the obtained initial 3D microstructural image using the extracted local features in each point of the obtained initial 3D microstructural image and the correspondence between the extracted local features and the minerals,
creating, by the computing system, the 3D mineral model of the sample from the segmented initial 3D microstructural image.

2. The method of claim 1 wherein the spatial registration is provided automatically in course of obtaining the mineral distribution images.

3. The method of claim 2 wherein the initial 3D microstructural and the mineral distribution images are obtained inside a chamber of scanning electron microscope.

4. The method of claim 1 wherein the spatial registration is provided separately.

5. The method of claim 4 wherein the separate image registration is based on side contour and/or surface peculiarities of the sample.

6. The method of claim 1 wherein the found correspondence between the extracted local features and the minerals is used for creating 3D mineral maps of similar samples.

7. The method of claim 1 wherein the created 3D mineral model is used for performing numerical simulations of various physical phenomena in the heterogeneous media.

8. The method of claim 1 wherein the heterogeneous media sample is a core.

9. The method of claim 1 wherein the initial 3D microstructural image is obtained by X-ray micro-computed tomography.

10. The method of claim 1 wherein the initial 3D microstructural image is a vector image.

11. The method of claim 10 wherein the vector image is a result of Multi-Energy X-ray (micro-, nano-) computed tomography.

12. The method of claim 11 wherein the vector image is a result of Dual-Energy X-ray (micro-, nano-) computed tomography

13. The method of claim 1 wherein the obtained mineral distribution images are one-dimensional.

14. The method of claim 1 wherein the obtained mineral distribution images are two-dimensional.

15. The method of claim 1 wherein the obtained mineral distribution images are three-dimensional.

16. The method of claim 1 wherein the mineral distribution images are obtained by Confocal Raman microscope.

17. The method of claim 14 wherein the mineral distribution images are obtained by Scanning Electron microscope.

18. The method of claim 14 wherein the mineral distribution images are obtained by Transmission Electron Microscope.

19. The method of claim 14 wherein the mineral distribution images are obtained by Optical microscope-based petrography analysis.

20. The method of claim 15 wherein the mineral distribution images are obtained by X-ray fluorescence microtomography.

21. The method of claim 15 wherein the mineral distribution images are obtained by Multi-Energy microtomography.

22. The method of claim 1 wherein the local features of the initial 3D microstructural image are calculated via voxel feature extraction.

23. The method of claim 1 wherein the local features of each point of the initial 3D microstructural image are calculated via cluster feature extraction.

24. The method of claim 23 wherein the clusters are mineral grains.

25. The method of claim 1 wherein the local features of each point of the initial 3D microstructural image are calculated via combination of voxel and cluster feature extraction.

26. The method of claim 1 wherein the segmentation of the initial 3D microstructural image is done point by point.

27. The method of claim 1 wherein the segmentation of the initial 3D microstructural image is done taking into account the local features of neighboring points.

28. The method of claim 1 wherein the segmentation of the initial 3D microstructural image is followed by post-processing.

29. A system for creating a 3D mineral model of a heterogeneous media sample, the system comprising:
a first image producing device configured to produce an initial 3D microstructural image of at least a part of the sample,
a second image producing device for obtaining a mineral distribution image of at least one part of the sample so that each obtained mineral distribution image at least partially overlaps with the produced initial 3D microstructural image,
a computing device coupled to the first and the second image producing devices and comprising:
at least one computer processor,
input and output devices in communication with the computer processors,
storage media storing one or more computer programs with computer-readable instructions that when executed by the computer processors cause the processors to perform the steps of:
providing spatial registration of the mineral distribution images and the initial 3D microstructural image in overlapping regions of the images,
extracting at least one local feature in each point of the 3D microstructural image,
finding correspondence between the extracted local features in each point of the overlapping regions in the initial 3D microstructural image, and minerals of the corresponding points in the overlapping regions in the mineral distribution images,
segmenting the initial 3D microstructural image using the extracted local features in each point of the initial 3D microstructural image and the correspondence between the extracted local features and the minerals,
creating the 3D mineral model of the sample from the segmented initial 3D microstructural image.
